(19) United States
(12) Patent Application Publication
(10) Pub. No.: US 2002/0187808 A1
(43) Pub. Date: Dec. 12, 2002

(54) Method and arrangement for encrypting data transfer at an interface in mobile equipment in radio network, and mobile equipment in radio network

(76) Inventors: Jari Vallstrom, (US); Petri Manninen, Oulu (FI)

Correspondence Address: PERMAN & GREEN, 425 POST ROAD, FAIRFIELD, CT, 06824, US

(21) Appl. No.: 10/165,153

(22) Filed: Jun. 6, 2002

(30) Foreign Application Priority Data
Jun. 12, 2001 (FI) 20011240

(51) Int. Cl. H04M 1/00

(52) U.S. Cl. 455/558; 455/556

(57) ABSTRACT

The invention relates to a method for securing the transfer of cipher keys and security codes between a mobile equipment (100, 300, ME) in a radio network and a SIM card (305) attached thereto. In the method according to the invention the mobile equipment and the SIM card attached thereto are first authenticated separately. After successful authentication, a cipher key KSM is given to the mobile equipment and the SIM card to be used by them. This cipher key is used to encrypt all other exchanges of passwords and security codes between the mobile equipment and the SIM card.

The invention relates to a method for securing the transfer of cipher keys and security codes between a mobile equipment of a radio network and a SIM card attached thereto. The invention further relates to a radio network, mobile equipment of a radio network and a SIM card attached thereto, which all utilize the encrypted data transfer according to the invention. The invention further relates to software means used for implementing the method according to the invention.

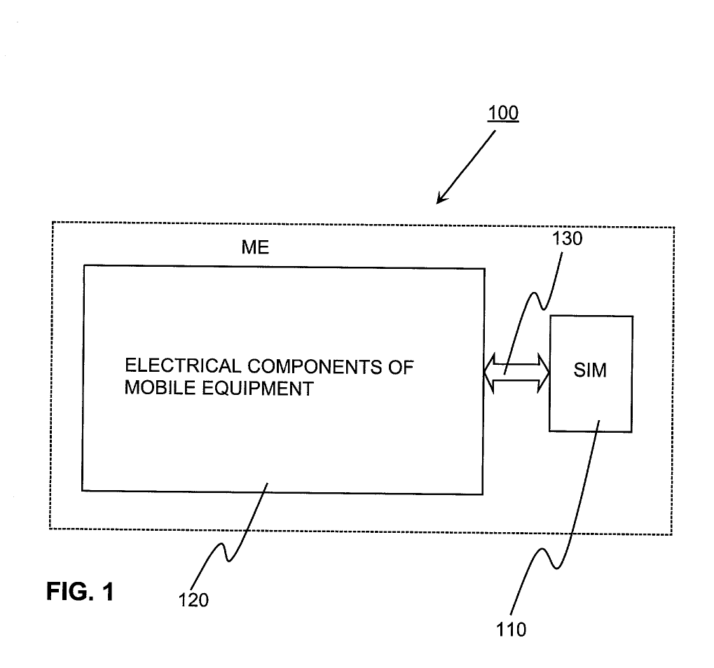

In various digital radio networks it is imperative that certain data, which are critical as regards the operation of the network and user privacy, are kept secret. Some typical examples of such radio networks include cellular telephone networks; cellular networks hereafter, based on different technologies. FIG. 1 shows, as an example, some essential components of a mobile equipment (ME) 100 in a radio network. A mobile equipment used in cellular networks includes a so-called SIM card 110 (Subscriber Identity Module). The SIM card holds user-specific data needed for activating the mobile equipment in a radio network and establishing and maintaining communications connections in the radio network. In one known radio network system, namely the cellular GSM (Global System for Mobile communications), each user is given a personal SIM card of his own and, in most cases, personal mobile equipment of his own. The SIM card has to be placed in the mobile equipment for the latter to function properly. The data in the SIM card are used first to verify the right of the user to the mobile equipment and, second, to authenticate the user as a genuine user of the cellular network. The various encryption procedures used in the GSM during a call are carried out based on various cipher keys, which can be stored in the SIM card. These cipher keys can be changed, if necessary, during an ongoing call/session.

There are, however, radio networks where it is necessary to employ long-term cipher keys shared by all users. This way it is easier to establish various encrypted group calls, for example. Such radio networks include e.g. various networks used by organizations concerned with public safety. A transnational public safety network TETRA, which is under development, is based on this concept, too. As this is a network to be used by various authorities, it is highly undesirable that authentication data or cipher keys used in network encryption leak outside the user group proper. Mobile equipment in such a radio network may include a SIM card 110 that may store cipher keys of different validity periods, such as the common cipher key CCK, static cipher key SCK and group cipher key GCK. These cipher keys are downloaded encrypted from the network to the SIM card in the mobile equipment and from the SIM card to the electrical components 120, the memory circuits, of the mobile equipment when the mobile equipment is activated. Data transfer 130 from the SIM card 110 to the electrical components 120 of the mobile equipment, however, takes place unencrypted. Therefore it is possible that a hostile party could capture the cipher keys of the cellular network during this data transfer/at this interface 130. If such a capture succeeds, the data security of the whole radio network is jeopardized because the hostile party may then use the data cipher keys of the radio network or hand them over to other unauthorized parties.

Another potential security problem involves a situation in which a hostile party succeeds in cracking the general SIM card encryption procedures used when new cipher keys are downloaded from the radio network to the SIM card for future use. If a hostile and skillful enough party knows a sufficient number of input and output parameter values used in the procedure, such a party may possibly break down the encryption at the interface 130 and then illegally use the information obtained.

An object of the present invention is to provide a novel method and arrangement for ensuring that the interface between mobile equipment proper and a SIM card attached thereto in a radio network can be made safer, in terms of data security, than what is possible to achieve through methods according to the prior art.

The objects of the invention are achieved by a procedure in which data are transferred over the interface between the SIM card and electrical components of a mobile equipment of a radio network only in an encrypted form.

A method according to the invention is characterized in that it comprises, after mobile equipment power-on,

phase A for authenticating a SIM card by the radio network using a computation algorithm 1 where after, if authentication was successful, the SIM card is authorized to use a cipher key,

phase B in which an encrypted cipher key is delivered to the mobile equipment, which cipher key the mobile equipment has to decrypt in order to become an authorized user of the radio network, and

phase C in which, if the decryption of the encrypted cipher key by the mobile equipment was successful, the cipher key is used in the transfer, in an encrypted form, from the SIM card to the mobile equipment of at least one other cipher key or security code used by the mobile equipment in data communication proper.

A radio network according to the invention is characterized in that it comprises means, available to the radio network, for separately authenticating a mobile equipment connected to the radio network and a SIM card attached to the mobile equipment.

Mobile equipment i.e. a terminal according to the invention is characterized in that it comprises means for separately authenticating the mobile equipment and a SIM card attached thereto, and means for transferring in an encrypted form passwords and security codes between the mobile equipment and a SIM card attached thereto after successful authentications.

A SIM card according to the invention is characterized in that it comprises means for transferring passwords and security codes in an encrypted form between a mobile equipment a SIM card attached thereto.

A software application according to the invention in a mobile equipment of a radio network is characterized in that it comprises

software means for issuing an authentication request,

software means for executing a computation algorithm 3,

software means for testing a cipher key decrypted with the computation algorithm 3, and

software means for using a cipher key to encrypt the transfer of passwords and security codes between a mobile equipment and a SIM card attached thereto.

A software application according to the invention stored on a SIM card of a mobile equipment of a radio network is characterized in that it comprises software means for using a cipher key to encrypt the transfer of passwords and security codes between a mobile equipment and a SIM card attached thereto.

Some advantageous embodiments of the invention are presented in the dependent claims.

The idea of the invention is basically as follows: The network has to separately authenticate both the mobile equipment ME of the radio network and the SIM card attached thereto before the cipher keys, which are needed by the user of the communications connection proper, are transferred over the interface between the SIM card and the ME. Authentication of the SIM card is advantageously done using a procedure according to the prior art. The mobile equipment may be authenticated using a procedure adapted from that according to the prior art but in which the input parameters of the authentication process may differ from those of the prior-art procedure, or alternatively the mobile equipment may be authenticated indirectly by conveying to the ME the cipher key according to the invention in an encrypted form. Decryption of a cipher key according to the invention can be performed only by an authentic ME.

So the network sends a cipher key according to the invention to a mobile equipment of a radio network, which ME is approved in a two-phase authentication procedure according to the invention. If necessary, that same cipher key is sent to the SIM card attached to the ME. The ME and the SIM card attached thereto will use the cipher key according to the invention when transferring prior-art cipher keys needed in the data traffic proper from the SIM card to the memory circuits of the ME when the ME is activated. A cipher key according to the invention may also be utilized in other data transfer between the SIM card and the ME.

An advantage of the invention is that the interface between the SIM card and ME is not used for transferring unencrypted information by means of which an unauthorized party could break the encryption of a radio network.

Another advantage of the invention is that a hostile intrusion in a radio network is more difficult than in prior-art methods in which information is transferred unencrypted over the interface between the SIM card and ME.

The invention is below described in detail. The description refers to the accompanying drawings in which

FIG. 1 shows as an example a SIM card and main components of a mobile equipment of a radio network and their interaction,

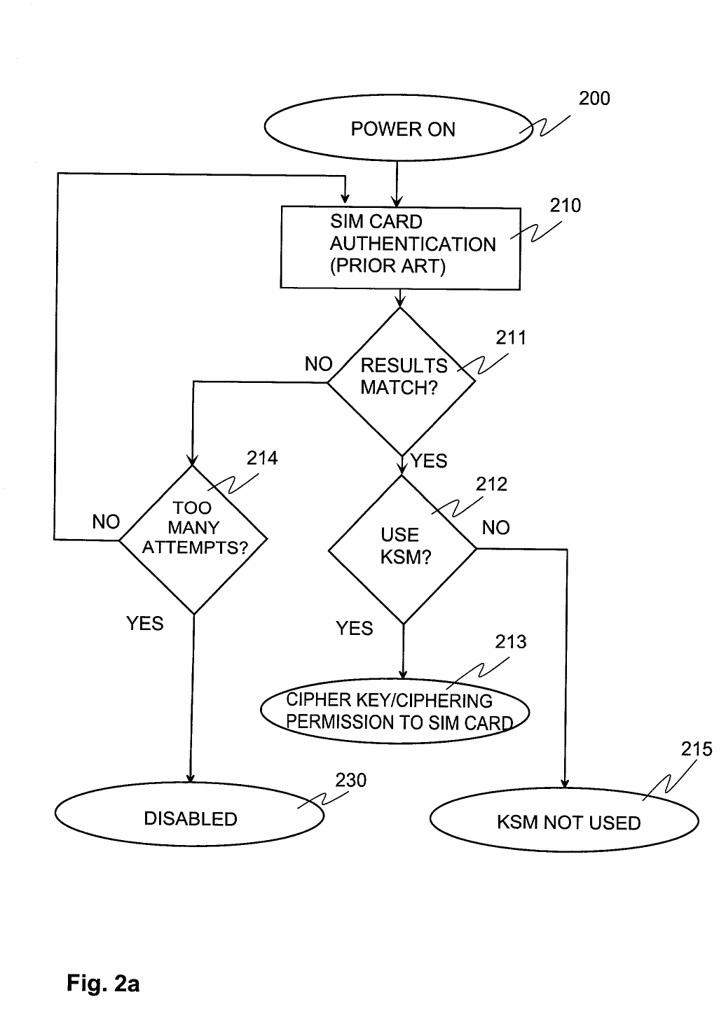

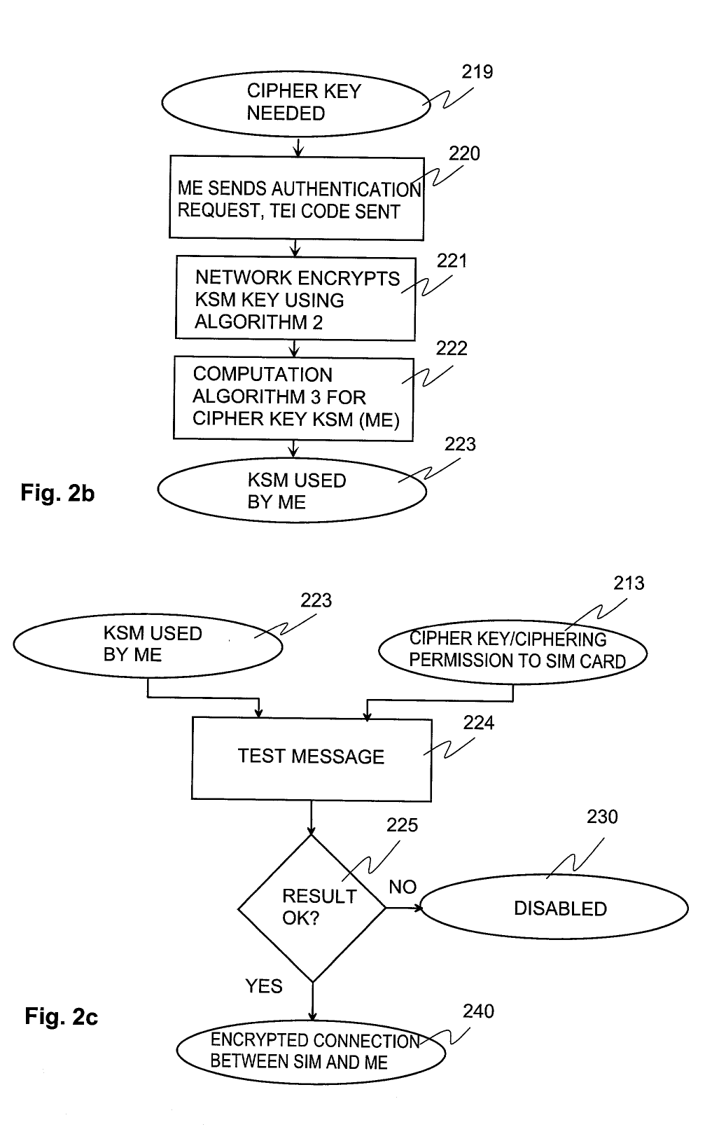

FIG. 2a shows an exemplary flow diagram of a SIM card verification method according to the invention,

FIG. 2b shows an exemplary flow diagram of a procedure according to the invention involving a mobile equipment ME of a radio network,

FIG. 2c shows an exemplary flow diagram of a procedure concerning the use of a cipher key KSM according to the invention, and

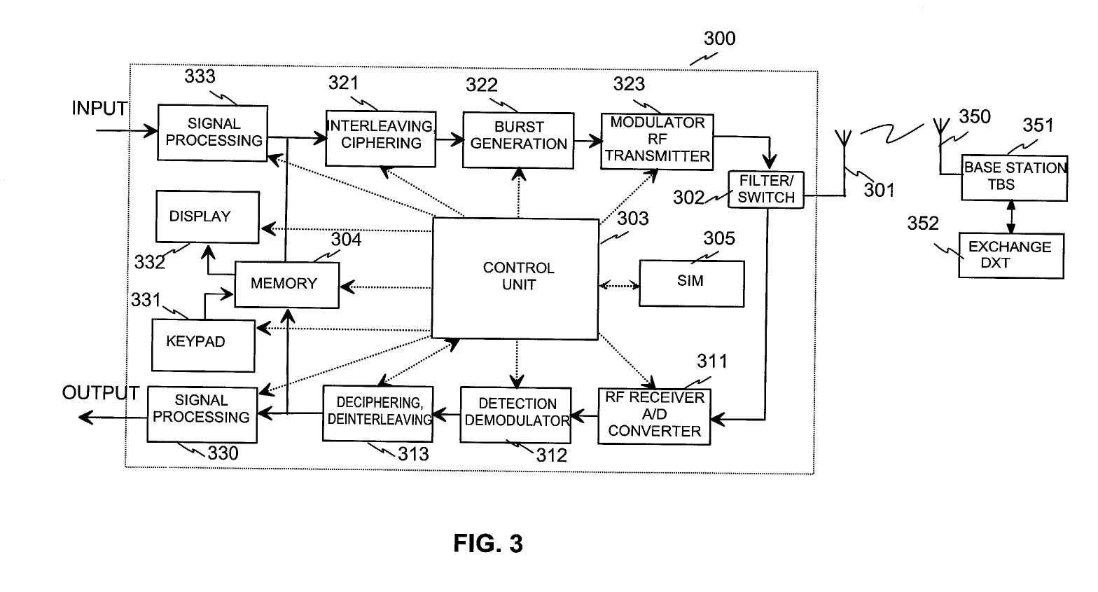

FIG. 3 shows as an example a cellular network and mobile equipment applying the procedure according to the invention.

FIG. 1 was already discussed in connection with the description of the prior art.

Use of the encryption method according to the invention requires that both the ME and the SIM card attached thereto support the encryption method according to the invention and both of these two are aware of this fact. There are a plurality of alternative ways in which the ME can tell the SIM card that it supports the method. For example, the information may be included in the initialization-handshake procedure that takes place at the interface between the ME and SIM card, or the ME may at a later stage indicate its support of the method according to the invention e.g. by setting the contents of a file reserved for this purpose on the SIM card such that it indicates that the ME supports the method according to the invention. Advantageously the SIM card's internal processor reads the status of the file. In an alternative method the SIM card inquires the ME about its ability to support the method according to the invention. This method can be used with a SIM card that supports the SIM Application Tool Kit feature. In a like manner it is possible to convey information about the SIM card's capabilities to the ME.

Moreover, the radio network in question also must support the method according to the invention. Information about the radio network's capabilities may be included in the signaling between the SIM card and radio network and between the ME and radio network. If the radio network does not support the method according to the invention it indicates this using an appropriate error message sent to the ME or SIM card.

So, a decision to apply the method according to the invention requires that all parties support it. In addition, the decision to apply the method has to be delivered to the various parties. By default, a decision to apply the method between a SIM card and ME can be made when both of them know that the other party supports the method according to the invention. A decision to apply the method between the radio network and ME can be conveyed by starting the signaling according to the invention and by interpreting possible relevant error messages as a negative decision concerning the application of the method.

FIGS. 2a, 2b and 2c show by way of example the main phases of the verification method according to the invention when the invention is applied in conjunction with a TETRA cellular network. The method according to the invention comprises three main phases in the first of which the SIM card is authenticated (phase A) and in the second, the ME connected with the SIM card is authenticated (phase B). In the third phase (phase C), a cipher key KSM according to the invention is taken into use. The phases may be executed either during one uninterrupted signaling session or in two separate signaling sessions. In addition, the mutual order of the first two phases A and B may vary. Phase A to authenticate the SIM card involves the authentication proper of the SIM card attached to a ME, which authentication may comply with the procedure according to the prior art. Successful authentication is advantageously followed by sending a cipher key KSM according to the invention to the SIM card. Phase B to authenticate the ME involves separate authentication of the mobile equipment either directly or indirectly and sending a cipher key KSM according to the invention to the ME.

In an advantageous method according to the invention, the TETRA network and the SIM cards store the data needed by each SIM card concerning the cipher key KSM according to the invention and the individual TETRA subscriber identification (ITSI) code and the computation algorithms needed in the verification method according to the invention.

Likewise in a procedure according to the invention, the TETRA network and mobile equipment ME store the data needed by each ME concerning their cipher keys K′ according to the invention and terminal equipment identity (TEI) codes and the computation algorithms needed in the verification method according to the invention. In addition, the TETRA network may advantageously comprise a random number generator in order to generate the random numbers needed in the method according to the invention.

A first advantageous embodiment of the invention starts with utilizing the prior-art authentication of the SIM card. The verification procedure according to this embodiment begins at step 200 of FIG. 2a. A SIM card according to the TETRA standards is attached to a ME, enabling an electrical connection between the SIM card and the other electrical components of the ME. In step 200 the power switch of the ME is turned into a position where power is switched on in the ME. When the power is turned on, the ME asks the user to enter the PIN code. When the correct PIN code has been entered, the ME is registered as a user of the TETRA network.

In step 210, the authentication of the SIM card is begun by the network in accordance with the prior art. In this authentication process, both the SIM card and network calculate security codes of their own using computation algorithm 1. In the case of a TETRA network, these codes are called RES1 and XRES1. In step 211 these codes are compared to each other by the TETRA network. If the codes differ, it is checked in step 214 whether the SIM card authentication can be attempted again or not. If the number of attempts exceeds a predetermined limit, the process moves on to step 230 in which the use of the SIM card in the TETRA network is prevented.

If in step 211 it is detected that the codes match, then a decision is made in step 212 about whether or not to use the cipher key KSM according to the invention. If the cipher key KSM is not to be used e.g. because some of the parties does not support the procedure according to the invention, the process moves on to step 215 in which the operation is in accordance with the prior art when various cipher keys are transferred between the SIM card and electrical components of the ME. Advantageously the TETRA network may indicate its inability to support the procedure in the form of an error message.

If a decision is made to use the cipher key KSM, the process moves on to step 213. Then in step 213 the TETRA network advantageously sends to the SIM card the cipher key KSM either encrypted or unencrypted. In this embodiment the cipher key KSM advantageously can be changed between uses. In another advantageous embodiment the cipher key KSM is permanently stored on the SIM card. In this embodiment the network only sends to the SIM card a permission/command to use the cipher key KSM according to the invention in the transfer of cipher keys between the ME and SIM card. In the ways described above the SIM card is authorized to take into use the cipher key KSM according to the invention.

In the embodiments described above, a successful authentication of the SIM card is followed by the second main phase B according to the invention, FIG. 2b, where the same cipher key KSM, which is already available to the SIM card, is conveyed to the ME, step 219. The ME advantageously informs the TETRA network that it supports encryption according to the invention and at the same time sends to the TETRA network its terminal equipment identity (TEI) in step 220. The TETRA network then encrypts the cipher key KSM according to the invention using a computation algorithm 2 known to the TETRA network, step 221. In addition to the KSM, advantageously the TEI, a TEI-specific cipher key K′ in the TETRA network, and possibly a random number “nm” are also input to the algorithm. The parameters used by the computation algorithm 2 are advantageously encrypted using a procedure known commonly to the ME and TETRA network, thereby preventing the cipher keys from wearing. The cipher key KSM according to the invention, which is encrypted using computation algorithm 2, and possible other computation parameters unknown to the ME are sent to the ME in conjunction with step 221.

When the TETRA network has in step 221 sent to the ME the cipher key KSM encrypted with computation algorithm 2 and the necessary other parameters used in the computation algorithm, the encrypted cipher key KSM can be decrypted in the ME using computation algorithm 3. This way the ME is indirectly authenticated, since only such a ME which knows the correct TEI and cipher key K′ is able to decrypt with computation algorithm 3 the cipher key KSM encrypted by the TETRA network. Thereby in step 223 the cipher key KSM according to the invention is available to the ME, too.

FIG. 2c shows an exemplary procedure for verifying that the cipher keys KSM delivered to the SIM card and ME are identical. Such verification begins with steps 223 and 213 in which both the SIM card and ME have got their cipher keys KSM. In step 214 a test message is sent which advantageously involves an addition of verification numbers to the encrypted communication between the SIM card and ME. The verification may also be realized by sending over the interface some data known to the SIM card and ME encrypted with a computation algorithm employing the cipher key KSM. Advantageously the sending party may be either one of the parties or they both may send a test message to one another. After that, the data are decrypted and matched against reference data known to the party. If in step 225 it is found that the exchange of data is acceptable, the cipher key KSM is taken into use in the communication between the SIM card and ME in step 240. If the result of step 225 is not acceptable, the process moves on to step 230 where the use of the ME is prevented.

Now it is possible to safely start transferring the cipher keys proper, needed in the data communication in the TETRA network, from the SIM card to the memory of a ME of the TETRA network. Since the data can now be transferred encrypted between the SIM card and electrical components of the ME, it would be difficult for a hostile party to capture the cipher keys proper, which are used in the data communication, when they are being transferred from the SIM card to the ME.

In the embodiments described above the TETRA network can identify the SIM-ME pair because the communications connection between the TETRA network and ME is not disconnected at any point during the authentication. In another advantageous embodiment, however, the steps for authenticating the SIM card and conveying the cipher key KSM according to the invention to the ME take place during separate signaling connections. In this embodiment the ME has to add an identifier, which can be associated with the SIM card, to its signaling in step 220 in which the TEI code is sent to the TETRA network. In the case of a TETRA network this additional identifier is advantageously the ITSI code.

In an advantageous embodiment of the invention the SIM card is first authenticated in the manner described in FIG. 2a. The authentication of the SIM card is followed by a step in which the ME is similarly authenticated through a process that corresponds to the SIM card authentication process illustrated in FIG. 2a. If the authentication of the ME yields a positive result, the cipher key KSM is sent to the ME either encrypted or unencrypted.

In an advantageous embodiment of the invention the authentication of the ME through a process according to FIG. 2b and the sending of the cipher key KSM to the ME are carried out before the authentication of the SIM card. If this involves two separate signaling connections, also both the ITSI and TEI code have to be sent to the TETRA network in conjunction with the authentication of the SIM card in step 211 so that the TETRA network can link the ME and SIM with each other.

In an advantageous embodiment of the invention the cipher key KSM according to the invention is stored permanently in the ME and in the network. In that case the cipher key KSM is sent only to the SIM card by the network either encrypted or unencrypted after a successful SIM card authentication.

In the embodiments described above the ME begins the step the end result of which is that the cipher key KSM is sent from the radio network to the ME. In an advantageous embodiment of the invention it is the radio network, which begins this step. This is advantageously preceded by signaling in which the radio network verifies that the ME supports the procedure according to the invention.

In a TETRA network, it is also possible that the SIM-ME pair authenticate the TETRA network. This is to ensure that unauthorized parties cannot capture the cipher keys used in the TETRA network. This network authentication is advantageously performed after the authentication of the SIM card and mobile equipment ME.

In an advantageous embodiment of the invention the cipher key KSM is initially stored only on the SIM card from which it is sent to the radio network using encryption methods commonly known to the SIM card and radio network. After that, the radio network sends the cipher key KSM to the ME, encrypted through encryption methods known to the ME and radio network. Together with the delivery of the cipher key KSM according to the invention, the other necessary parameters needed in the decryption process are delivered to the various parties. In this embodiment the cipher key KSM may be either fixed or it may vary between uses. Advantageously the encryption methods used for encrypting the cipher key KSM are similar to those described in the embodiments described above.

In the embodiments described above the necessary random numbers and parameters used in the encryption process may be obtained either from a separate random number generator or they are fetched from a random number table stored in the system.

In an embodiment of the invention the cipher key KSM is advantageously conveyed to the ME using prior-art TETRA air interface encryption. In that case, when the SIM card has been authenticated in the TETRA network, a dynamic cipher key DCK is delivered to the SIM card and ME. This same cipher key DCK is also available to the network. A KSM encrypted using the cipher key DCK can be sent from the TETRA network to the ME and in an advantageous embodiment, also to the SIM card. The ME may be requested to be authenticated by the TETRA network before the cipher key KSM according to the invention is sent to the ME. Alternatively, the cipher key DCK may be used instead of the cipher key KSM according to the invention in a computation algorithm, which is used to encrypt the data, transfer between the SIM card and ME. These methods, however, do not provide the same kind of data security as the methods described above, because the cipher key DCK has to be sent to the ME unencrypted.

FIG. 3 shows in the form of a simplified block diagram a mobile equipment (ME) 300 of a TETRA network, a SIM card attached thereto, and the connection of the ME with the TETRA cellular network. The ME comprises an antenna 301 to receive radio frequency, or RF, signals transmitted by TETRA base stations (TBS) 351. A received RF signal is conducted by a switch 302 to a RF receiver 311 where the signal is amplified and converted digital. The signal is then detected and demodulated in block 312. Block 313 performs deciphering and deinterleaving. Signal processing is then performed in block 330. The received data may be saved as such in the ME's 300 memory 304 or alternatively the processed packet data are transferred after signal processing to an external device such as a computer. A control unit 303 controls the aforementioned receiving blocks in accordance with a program stored in the unit. By means of the receiving blocks (311-313) the ME 300 also receives the messages used in the authentication procedure according to the invention from a TETRA base station (351).

Transmission from a TETRA mobile equipment 300 is carried out e.g. as follows. Controlled by the control unit 303, block 333 performs possible signal processing on the data, and block 321 performs the interleaving and ciphering on the processed signal to be transmitted. Bursts are generated from the encoded data in block 322 which are modulated and amplified into a transmission RF signal, block 323. The RF signal to be transmitted is conducted to the antenna 301 via switch 302. Also the aforementioned processing and transmission functions are controlled by the control unit 303. By means of the transmitting blocks 321-323 the ME also sends the messages used in the authentication procedure according to the invention to TETRA base stations.

In the TETRA mobile equipment 300 of FIG. 3, the components that are essential from the invention's perspective include the SIM card 305, the memory 304 of the ME 300, the signal processing block 333, the interleaving/ciphering block 321, as well as the control block 303 which processes the information contained in the messages and controls the operation of the mobile equipment both in general and during the procedure according to the invention. Part of the memory 304 of the mobile equipment and SIM card 305 has to be allocated to application programs, cipher keys and computation algorithms needed in the authentication according to the invention.

The hardware requirements imposed by the invention on the radio network proper and its potential base stations 351 or corresponding arrangements, which convey communication between a ME and the network, are quite small compared to the prior art. A TETRA base station (TBS) 351 or a digital exchange for TETRA (DXT) 352 has access to a database (not shown in FIG. 3) which contains the data of the TETRA mobile equipment operating in the network. These data include e.g. the TEI codes, ITSI codes, cipher keys K′ needed in the procedure according to the invention, random numbers “nm” or the random number generators needed to generate them, cipher keys KSM, and computation algorithms 2 and 3. Likewise, the base stations or exchanges have access to software means to execute the computation algorithms and functional steps according to the invention.

The embodiments described above are naturally exemplary only and do not limit the application of the invention. Especially it should be noted that even though the above examples mainly pertain to a TETRA cellular network, the invention can be applied to any other digital radio network where it is desirable to ensure that user data are kept secret at the interface between the SIM card and the terminal. Such systems include especially the GSM, DCS1800 (Digital Communications System at 1800 MHz), IS-54 (Interim Standard 54) and the PDC (Personal Digital Cellular), the UMTS (Universal Mobile Telecommunications System) and FPLMTS/IMT-2000 (Future Public Land Mobile Telecommunications System/International Mobile Telecommunications at 2000 MHz).

Furthermore, the inventional idea may be applied in numerous ways within the scope defined by the appended claims.

1. A method for securing the transfer of cipher keys and security codes between a mobile equipment used in a radio network and a SIM card attached thereto, which method comprises, after mobile equipment power-on,
phase A for authenticating a SIM card by the radio network using a computation algorithm 1 where after, if authentication was successful, the SIM card is authorized to use a cipher key KSM,
phase B in which the encrypted cipher key KSM is delivered to the mobile equipment, which cipher key KSM the mobile equipment has to decrypt in order to become an authorized user of the radio network, and
phase C in which, if the decryption of the encrypted cipher key KSM by the mobile equipment was successful, the cipher key KSM is used in the transfer, in an encrypted form, from the SIM card to the mobile equipment of at least one other cipher key or security code used by the mobile equipment in data communication proper.

2. A method according to claim 1 wherein in conjunction with the authorization in phase A the cipher key KSM is sent from the network to the SIM card.

3. A method according to claim 1 wherein in conjunction with the authorization in phase A a permission is sent from the network to the SIM card enabling the latter to use the cipher key KSM stored permanently in the memory of the SIM card.

4. A method according to claim 1 wherein the cipher key KSM is used also to encrypt other data to be transferred.

5. A method according to claim 1 wherein the radio network is a TETRA network.

6. A method according to claim 1 wherein the phase B comprises
a step in which the mobile equipment sends an authentication request to the radio network,
a step in which the network calculates a security code using a computation algorithm 2,
a step for sending the security code calculated by the network to the mobile equipment and
a step for calculating a security code in the mobile equipment using a computation algorithm 3 in order to discover the cipher key KSM.

7. A method according to claim 6 wherein he authentication request sent to the radio network comprises at least one of the following: equipment identity TEI, subscriber identity ITSI.

8. A method according to claim 1 where the phase C comprises
a step for transferring a message processed using the cipher key KSM between the SIM card and the mobile equipment and
a step for verifying the authenticity of the transferred message where after the cipher key KSM is used for securing the transfer from the SIM card to the mobile equipment of passwords used in data communication proper.

9. A method according to claim 6 wherein the computation algorithm 2 uses as source data for the computation at least one of the following: the cipher key KSM, a code identifying the mobile equipment such as TEI, a mobile equipment specific cipher key K′ modified from the TEI code, or a random number “nm”.

10. A method according to claim 6 wherein in conjunction with the sending of a security code calculated using the computation algorithm 2 a code number is sent to the mobile equipment so that it is possible to discover the random number “nm” used.

11. A method according to claim 1 wherein the cipher key KSM is changed for each time the mobile equipment is switched on.

12. A method according to claim 6 wherein the computation algorithm 2 is the same as the computation algorithm 1.

13. A radio network comprising exchanges, base stations and mobile equipment, where
the exchanges are provided with means for directing messages between base stations,
base stations are provided with means for generating messages and sending messages to mobile equipment, and with means for receiving messages sent by mobile equipment,
mobile equipment are provided with means for sending and receiving messages to/from base stations, and
the radio network further comprises means, for separately authenticating a mobile equipment connected to the radio network and a SIM card attached to the mobile equipment.

14. A radio network according to claim 13 wherein the means available to a base station for authenticating a mobile equipment and a SIM card attached to thereto comprise
means for receiving an authentication request sent by a mobile equipment,
means for executing a computation algorithm 2, and
means for sending a security code obtained through computation algorithm 2 to the mobile equipment.

15. A radio network according to claim 13 wherein the means for executing the computation algorithm 2 include data available to the radio network concerning the terminal equipment identities TEI, individual TETRA subscriber identifications ITSI, cipher keys K′, random numbers “nm”, computation algorithms 1, 2 and 3, as well as cipher keys KSM.

16. A radio network according to claim 15 wherein the radio network further comprises means for sending the cipher key KSM to a mobile equipment and to a SIM card attached thereto.

17. A radio network according to claim 13 wherein it is a TETRA network.

18. A mobile equipment of a radio network, provided with means for connecting with a certain radio network to receive messages, to transmit messages, and to store messages, and which further comprises means for performing separate authentications of the mobile equipment and a SIM card attached thereto, and means for transferring, after successful authentications, passwords and security codes encrypted between the mobile equipment and the SIM card attached thereto.

19. A mobile equipment according to claim 18 wherein the means for performing the authentication of the mobile equipment comprise
means for receiving from the network a security code calculated using a computation algorithm 2, and
means for deriving, using a computation algorithm 3, a cipher key KSM from the received security code from the computation algorithm 2.

20. A mobile equipment according to claim 19 wherein the mobile equipment further comprises means for communicating a test message between the mobile equipment and the SIM card, and after the approval of the test message the communication between the mobile equipment and the SIM card is arranged so as to be encrypted using the cipher key KSM.

21. A SIM card attached to a mobile equipment, comprising means for starting an authentication of the SIM card after power is switched on in the mobile equipment, and means for transferring passwords and security codes encrypted between the mobile equipment and the SIM card attached thereto.

22. A SIM card according to claim 21 wherein the SIM card further comprises means for receiving after a successful authentication a cipher key KSM sent by the radio network.

23. A SIM card according to claim 22 wherein the encryption of the transfer of passwords and security codes between the mobile equipment and SIM card is arranged so as to be realized using the cipher key KSM.

24. A software application in a mobile equipment of a radio network, which comprises
software means for issuing an authentication request,
software means for executing a computation algorithm 3,
software means for testing a cipher key KSM decrypted with the computation algorithm 3, and
software means for using the cipher key KSM to encrypt the transfer of passwords and security codes between a mobile equipment and a SIM card attached thereto.

25. A software product according to claim 24 stored on a data communication medium.

26. A software application stored on a SIM card attached to a mobile equipment of a radio network, which software application further comprises software means for using a cipher key KSM to encrypt the transfer of passwords and security codes between the mobile equipment and the SIM card attached thereto.

27. A SIM card according to claim 26 wherein it further comprises software means for receiving the cipher key KSM from a network after a successful authentication.

28. A software product according to claim 26 or 27 stored on a data communication medium.
